(19) United States
(12) Patent Application Publication
(10) Pub. No.: US 2013/0185304 A1
(43) Pub. Date: Jul. 18, 2013

(54) RULE-DRIVEN RUNTIME CUSTOMIZATION OF KEYWORD SEARCH ENGINES

(71) Applicants: Yunyao Li, San Jose, CA (US); Sriram Raghavan, Bangalore (IN); Huaiyu Zhu, Union City, CA (US)

(72) Inventors: Yunyao Li, San Jose, CA (US); Sriram Raghavan, Bangalore (IN); Huaiyu Zhu, Union City, CA (US)

(73) Assignee: INTERNATIONAL BUSINESS MACHINES, Armonk, NY (US)

(21) Appl. No.: 13/351,347

(22) Filed: Jan. 17, 2012

(51) Int. Cl. G06F 17/30

(52) U.S. Cl. 707/740; 707/E17.089

(57) ABSTRACT

Described herein are methods, systems, apparatuses and products for rule-driven runtime customization of keyword search engines. An aspect provides a method for rule-driven customization of keyword searches, including: receiving by a computer an input keyword query; determining from the input keyword query and a dataset to be queried at least one rule selected from the group consisting of: a re-write rule; a category ranking rule, and a category grouping rule; and applying the at least one rule to generate search results based on domain knowledge of the dataset. Other embodiments are disclosed.

### FIELD OF THE INVENTION

The subject matter presented herein generally relates to rule-driven runtime customization of keyword search engines.

### BACKGROUND

With the explosion of information available in various forms (for example, web pages, emails, desktop files, et cetera), search engines are becoming increasingly important, largely due to their capability of supporting simple keyword queries to help people easily and quickly locate needed information. Search engines have been widely adapted to different domains in different scales, from Internet searching to desktop searching, as keyword searching is becoming the de facto access method for many types of information, including enterprise database/information searching.

### BRIEF SUMMARY

One aspect provides a method for rule-driven customization of keyword searches, comprising:receiving by a computer an input keyword query; determining from the input keyword query and a dataset to be queried at least one rule selected from the group consisting of: a re-write rule; a category ranking rule, and a category grouping rule; and applying the at least one rule to generate search results based on domain knowledge of the dataset.

Another aspect provides a computer program product for rule-driven customization of keyword searches, comprising: a computer readable storage medium having computer readable program code embodied therewith, the computer readable program code comprising: computer readable program code configured to receive an input keyword query; computer readable program code configured to determine from the input keyword query and a dataset to be queried at least one rule selected from the group consisting of: a re-write rule; a category ranking rule, and a category grouping rule; and computer readable program code configured to apply the at least one rule to generate search results based on domain knowledge of the dataset.

A further aspect provides a system for rule-driven customization of keyword searches, comprising: at least one processor; and a memory device operatively connected to the at least one processor; wherein, responsive to execution of program instructions accessible to the at least one processor, the at least one processor is configured to: receive an input keyword query; determine from the input keyword query and a dataset to be queried at least one rule selected from the group consisting of: a re-write rule; a category ranking rule, and a category grouping rule; and apply the at least one rule to generate search results based on domain knowledge of the dataset.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example architecture for customization of keyword queries.

FIG. 2 illustrates an example flow for customization of keyword queries.

FIG. 3 illustrates example keyword query customizations.

FIG. 4 illustrates an example computer system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the claims, but is merely representative of those embodiments.

Reference throughout this specification to “embodiment(s)” (or the like) means that a particular feature, structure, or characteristic described in connection with the embodiment is included in at least one embodiment. Thus, appearances of the phrases “according to embodiments” or “an embodiment” (or the like) in various places throughout this specification are not necessarily all referring to the same embodiment.

Furthermore, the described features, structures, or characteristics may be combined in any suitable manner in different embodiments. In the following description, numerous specific details are provided to give a thorough understanding of example embodiments. One skilled in the relevant art will recognize, however, that aspects can be practiced without certain specific details, or with other methods, components, materials, et cetera. In other instances, well-known structures, materials, or operations are not shown or described in detail to avoid obfuscation.

While key word searching is very convenient in certain contexts, challenges still face conventional search engines, particularly for those built on top of data from a closed domain (for example, enterprise intranet or email databases, referred to herein as “enterprise dataset(s)” or simply “dataset(s)”). For example, the way that a query is posed by a user to search for a particular piece of information may be different from the way that information is described in the underlying dataset. Search engines at the Web scale often rely on information redundancy to handle this challenge. For example, when the same information comes from different resources, it is likely that some of the resources will describe the information in a similar way as the user query and thus can be found by the user query. However, such an assumption typically does not hold for closed domains. For instance, on a company intranet, when a user types in a generic query for information, if the documents containing the information only describe it using an official term, then the search engine is very unlikely to find such documents.

Additionally, when search results are returned to the user for a given query, the results are returned in the order of their “ranking”, typically based on scores associated with each result computed by an internal search algorithm. However, the top results sometimes can come from the same data resource(s), and what the user is looking for may be buried deep in the results. Search engines at the Web level seek to remedy this issue by grouping results from the same web sites. It has been unclear, however, how to systematically group results that can not be so clearly separated from each other (for instance, in intranet database searching).

Moreover, traditionally the order of search results depends on ranking scores associated with each result obtained from an internal search algorithm. Even if the system administrator knows that for certain queries (for example, “customer relations”) some pages (for example, pages from a particular department in the company, such as customer service (CS)) are more important than others (for example, internal news articles or external cites dealing with customer relations), there is no systematic way for the system administrator to interfere with the result ranking algorithm.

Accordingly, an embodiment provides a method for generating additional queries for a given keyword query. An embodiment enables the search engine to address the mismatch between a user's query and the underlying data. A process for query generation starts with the input search query and, through a sequence of processing steps, produces a set of target search queries to be issued against the underlying data.

An embodiment provides for ranking and grouping search results. An embodiment takes the results produced from executing each individual query and through a process of merging and grouping, produces a final ranked list of results. This enables an administrator of a search engine to interfere with the result ranking. This also enables a diverse set of search results to be presented to the user as top search results.

An embodiment provides for defining runtime rules that can be used to influence query generation, as well as ranking and grouping of the search results. A runtime rule may be manually defined or automatically generated. The semantics of a runtime rule may depend on a collection of dictionaries. When the user inputs a search query, an embodiment enables the search engine to determine which runtime rules match the query and, when applicable, generate alternative queries as well as information to rank/group search results based on the runtime rules.

The description now turns to the figures. The illustrated example embodiments will be best understood by reference to the figures. The following description is intended only by way of example and simply illustrates certain example embodiments representative of the invention, as claimed.

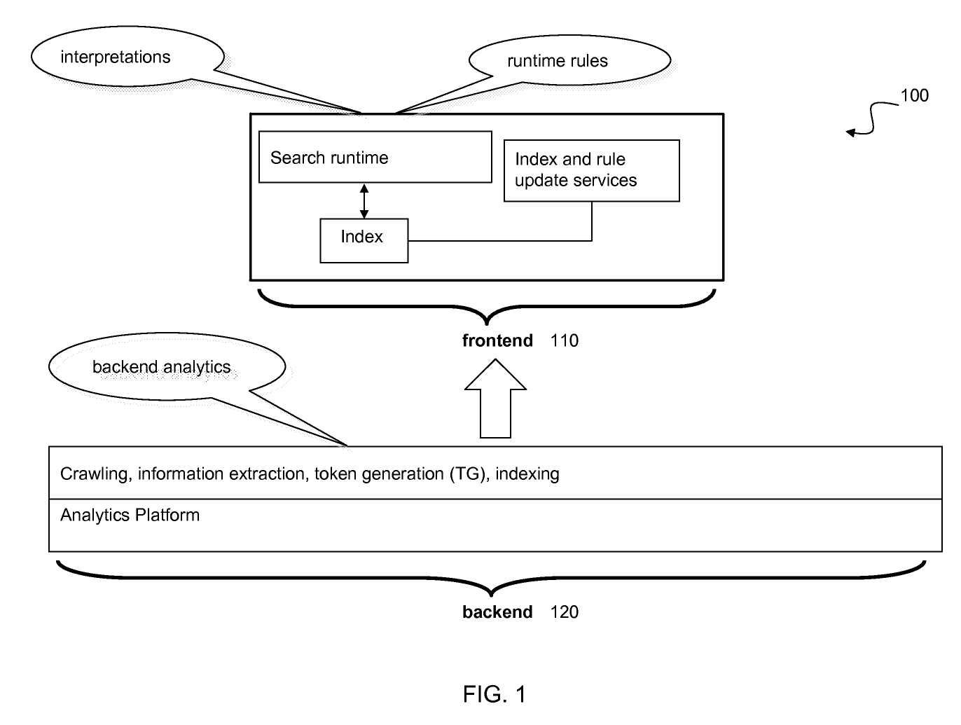

FIG. 1 illustrates example system architecture 100. At a high-level, the runtime of an example search engine according to an embodiment broadly includes operations that can be broken down into two phases: query generation and result aggregation. The example system architecture includes front end components 110, which implement the query generation and result aggregation functions, and back end components 120, which support the processing by providing necessary domain information-based rules gleaned from domain-specific/enterprise dataset(s) being searched via back end processing such as crawling, information extraction, token generation, indexing, et cetera, as further described herein.

Query generation starts with an input search query and through a sequence of processing steps produces a set of target queries (for example, queries from Apache Software Foundation's Lucene software) to be issued against underlying indexes. For example, an index is made up of a series of multiple Lucene indexes for each search collection.

Result aggregation takes the results produced from executing each individual search query and through a process of merging and grouping produces a final ranked list. Runtime rules may be used to influence both the query generation and result aggregation phases.

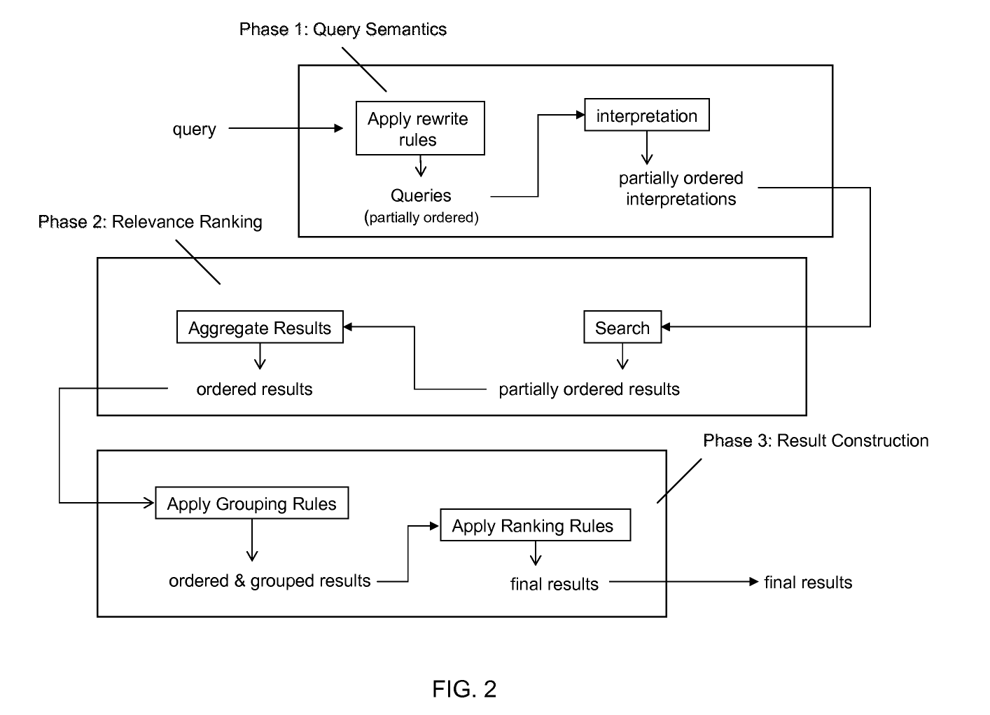

FIG. 2 illustrates an example of the runtime processing according to an embodiment. Responsive to a user input keyword search query, in a first phase (1), query semantics are used to determine if one or more re-write rules should be applied to re-write the user's query, as appropriate for the particular enterprise dataset being searched. If a re-write rule is to be applied, this involves formulating one or more queries in addition to the user submitted query with which to search the dataset. If a re-write rule is applied, then the additional queries may be utilized in addition to (supplement) or in lieu of the original query. If more than one query is utilized, the queries may be partially ordered, thus influencing the query results, as further described herein. However, if no re-write rule(s) is/are applied, then the original query may be issued.

Query interpretation is thus included in the query semantics phase. The queries are processed to understand the user submitted query and formulate the additional queries with regard to searching the dataset in question with a searching algorithm, using domain specific knowledge.

Responsive to the query semantics phase (1), an embodiment implements a relevance ranking phase (2) in which relevance ranking takes place. Here, an embodiment implements interpretations execution and forms a partially ordered set of results based on the interpreted queries. These partially ordered results are then aggregated and ordered according to one or more metrics that are appropriate given some domain specific knowledge of the underlying dataset being searched, as further described herein.

In a result construction phase (3), an embodiment prepares the results for output to the user that submitted the query. Here, an embodiment applies grouping rules (that help to avoid repetitive results from similar sources/provide more diversity in the search results) to form ordered and grouped results. The ordered and grouped results may also be subjected to ranking rules. Again, the ranking rules may apply domain specific knowledge to appropriately present query results to the user as final output.

As a specific example, referring to FIG. 2, assume that an embodiment has the following rules in the runtime:

Re-write rule: Equals [d=country]->NEW_OVER_ORIG [!0] cs

Grouping rule: ANY->cs_pages, news, wiki

Ranking rule: cs->news, cs_pages

The example rewrite rule specifies that if a query matches the name of a country, an embodiment creates an alternative query with the country name and CS (customer service). For example, an input query “Canada” will be re-written into “Canada CS”. The example grouping rule groups results from category “cs_pages” together. Similarly, results from category “news” are grouped together, et cetera. The example ranking rule specifies that queries containing the term “cs” will be ranked higher than results from category “news”, and higher than those results from “cs_pages”.

Accordingly, given a query input of “Canada”, the above rewrite rule will generate an alternative query “Canada cs”. The partially order interpretation can be a list such as the following (assuming a document has only one field: pagetitle):

pagetitle: canada cs

pagetitle: canada

From the index, assume that the first interpretation “pagetitle: canada cs” brings up 4 documents while the second interpretation “pagetitle: canada” brings up 6 documents. For instance, there may be two lists of ranked results: First list: d1, d2, d3, d4 (d1 and d3 from the category “cs_pages” and d2 and d4 from the category “news”); and Second list: d5, d6, d1, d2, d3, d4 (d5, d1, d3 from the category “cs_pages” and d6, d2, d4 from the category “news”’). Note that in this example, the results brought up by the first interpretation also contained those brought up by the second interpretation (corresponding to the original query), but the documents are ranked in a different order.

Then an embodiment merges the results together into one list: d1, d2, d3, d4, d5, d6. Thus, the results from the first interpretation are ranked higher than those from the second interpretation. Then an embodiment applies the grouping rules. In this example there is only one grouping rule that is applied. On applying it, an embodiment provides the groups (d1, d3, d5) (d2, d4, d6), where “( )” indicates grouping of results. Now an embodiment applies the ranking rule and ranks the results from the category “news” higher than those results from “cs_pages”. Thus, the result is (d2, d4, d6) (d1, d3, d5). This final result will then be rendered and presented to the end user.

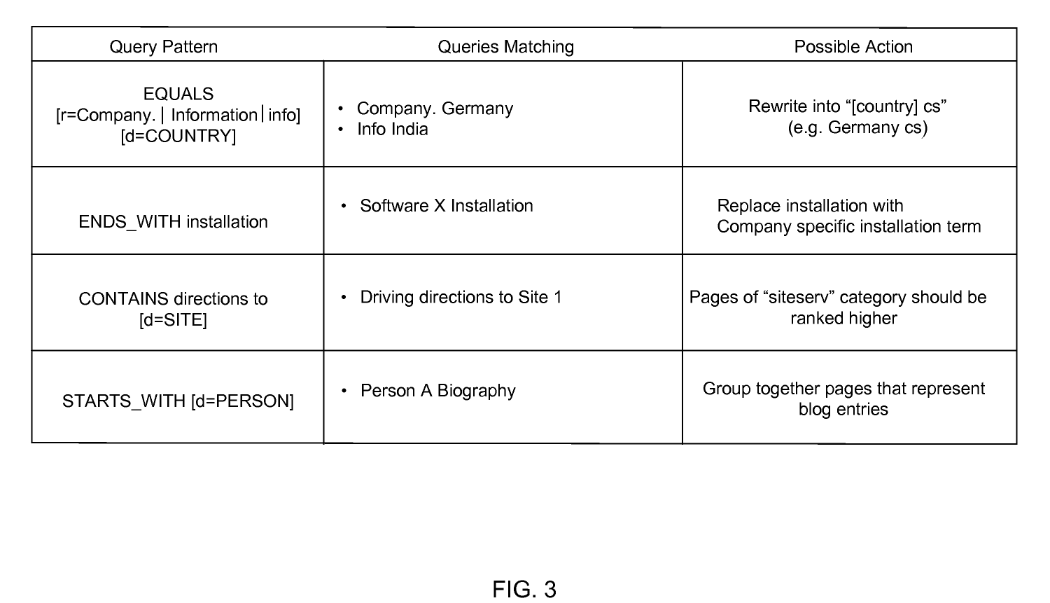

Referring to FIG. 3, examples of runtime rules are illustrated. A generic runtime rule is of the form:

QUERYPATTERN→ACTION

where QUERYPATTERN is a pattern expression applied to the input search query, and the ACTION describes an action to be performed if the input search query matches this expression. The precise form of ACTION is dependent on the particular rule type in question. In an example implementation, the runtime configuration points to a collection of rules files maintained on disk. As part of initialization, the runtime environment reads the referenced files, parses, and loads the rules into memory. Rule updates can be pushed dynamically by editing the rule files and instructing the engine (for example, via an HTTP request) to reload and update its internal data structures.

Note that the search runtime has access to a collection of dictionaries. Some examples of the dictionaries used may include enterprise/company sites, countries, regions, concepts, et cetera. These dictionaries are used by the runtime internally as part of its query processing algorithm. However, these same dictionaries can also be referenced within runtime rules. Indeed, as further described herein, runtime rules and dictionaries go hand-in-hand. The ability to specify matches between query terms and one or more of these dictionaries is a very useful construct when composing runtime rules.

Query patterns can be viewed as very specialized regular expressions designed specifically for matching against parsed queries. However, note that query patterns are much less expressive than full-blown regular queries. Furthermore, the matching regimen for query patterns may not be specified at the level of individual characters but rather at the level of parsed query tokens. For example, consider the query pattern EQUALS COMPANY Germany (where “COMPANY” or “COMPANY NAME” may be a specific company name). This pattern begins with the keyword EQUALS followed by two plain text terms. Both order and position of the terms are important, that is, a query will match if it has two adjacent terms, the first one of which is the string literal “COMPANY” (or rather the company name in question) and the second of which is the string literal “Germany”. The presence of EQUALS is to indicate that a match of this pattern must involve the entire parsed query and not just portions of it. In other words, the parsed query must have no other text tokens besides these two (the presence or absence of other fielded tokens does not affect the match).

Thus, the following queries: “COMPANY NAME Germany”, “COMPANY NAME Germany category:cs”, and “region: emea COMPANY NAME Germany”, match “EQUALS COMPANY NAME Germany”, but the queries: “COMPANY NAME Germany lab” and “Germany COMPANY NAME” do not. Order-independent matching is possible, for example by using the syntax “{ }” around the query pattern. For example, the query pattern “EQUALS {COMPANY NAME Germany}” matches both queries “COMPANY NAME Germany” and “Germany COMPANY NAME”.

Now consider the more complex query pattern “EQUALS [r=COMPANY NAME |linformation|info] [d=COUNTRY]”. Instead of simple string literals, this pattern uses two kinds of terms: a regular expression term (denoted by prefixing the text with “r=”) and a dictionary term (denoted with a “d=” prefix). The regular expression term will match any parsed token whose text matches the given regular expression (in this case, the regular expression specifies that the parsed query token must contain one of the words “COMPANY NAME”, “information” or “info”). The dictionary term will match any parsed token whose text matches the dictionary named COUNTRY. Thus, “COMPANY NAME Germany”, “info India”, and “category:cs region:emea information France”, are all examples of queries that will match the above pattern, assuming that the COUNTRY dictionary is populated as one would expect.

In addition to EQUALS, an embodiment may support other ways of controlling the match. For example, STARTS_WITH, ENDS_WITH, and CONTAINS may be implemented. STARTS_WITH patterns only dictate how a parsed query must begin and allow any number of additional tokens to follow the ones that match the pattern. ENDS_WITH similarly allows additional tokens at the beginning of the parsed query as long as the tokens at the tail end of the query match the pattern. Lastly, CONTAINS only requires some contiguous sequence of tokens in the parsed query to match the pattern, allowing additional tokens before and/or after. When none of the four keywords CONTAINS, STARTS_WITH, ENDS_WITH, or EQUALS are mentioned, the rule engine may default to CONTAINS. Table 1 lists additional examples of such patterns along with matching parsed queries, and FIG. 3 also provides additional examples.

TABLE 1

| | |
|---|---|
| CONTAINS directions to [d=SITE] | Driving directions to Site 1; |
| | Directions to Site 2 from Site 3 |
| STARTS_WITH [d=PERSON] | Person A; |
| | Person A's Biography; |
| | Person B web site |

Example formal Extended Backus-Naur Form (EBNF) grammar for query patterns runtime are listed below. Here dictname_string_literal is any valid Java® identifier and regex_string_literal is any valid Java® regular expression. Java is a registered trademark of Oracle Corporation and/or its affiliates.

QUERYPATTERN = PATTERN_TYPE PATTERN_TERM+ |
PATTERN_TYPE “{” PATTERN_TERM+ “}” | “ANY”
PATTERN_TYPE = “EQUALS” | “CONTAINS” | “STARTS_WITH” |
“ENDS_WITH” | “”
PATTERN_TERM = “[” DICT_TERM | MAP_DICT_TERM|
REGEX_TERM | string_literal “]”
DICT_TERM = “d=”dictname_string_literal
MAP_DICT_TERM =
“d=”dictname_string_literall(“(”entry_string_literal”)”)?
REGEX_TERM = “r=”regex_string_literal

As described herein, a general runtime rule is of the form QUERYPATTERN→ACTION where the ACTION determines the type of the rule. An example embodiment provides three different rule types: plain rules, category rules, and rewrite rules.

Plain rules are those runtime rules for which actions are not specified at a per-rule level but implicitly defined based on the file in which the rules are listed. As a result, the right hand side (ACTION part) of these rules is empty and the entire rule consists of just a query pattern. A collection of such query patterns forms a plain rule file. The action associated with such a file is triggered whenever a query matches any of the patterns specified in that file. Hence, as described herein, the order of the rules in the rule file is immaterial for plain rules. Plain rules may be used when there is a need to enable/disable configuration options or features based on patterns in the query. While there are no constraints on what those options or features can be, at least in one example embodiment, uses of plain rues are for UI-related configuration tasks.

For example, one use case for plain rules is to control when and how results from external web sites should be included within search results. For instance, by default, an example embodiment may only include results from enterprise (intranet) web sites, plus known domains such as partner businesses, et cetera (enterprise dataset). However, using plain rules, search administrators can choose to override default settings and automatically enable inclusion of external pages for queries of choice. Four such rules are listed below:

EQUALS [r=discounts?]
CONTAINS [d=EXTERNAL_SOFTWARE]
CONTAINS business [r=cards?]
CONTAINS [r=beneplace|netbenefits?|benefits?]

Thus, for queries like “discounts”, “business cards”, “netbenefits”, “software download”, “linux kernel”, an example embodiment will automatically include results from external web sites. Note that external software products may be listed in the EXTERNAL_SOFTWARE dictionary. Other examples of the use of plain rules include controlling the appearance of drop-down menus for restricting results by geography and the display of search results from specific search collections.

Using category rules, each document can be automatically classified by the search engine into one or more categories. Category rules allow a search administrator to specify, based on query patterns, when and how results of a search query should be grouped and ranked based on categories. Category rules may come in two flavors, grouping rules and ranking rules. Both flavors may be identical in syntax but may be distinguished by placing them in separate files, as shown in Table 2.

TABLE 2

| | |
|---|---|
| OR | Generated query and incoming query are ranked |
| | the same |
| NEW_OVER_ORIG | Generated query is ranked higher than the |
| | incoming query |
| ORIG_OVER_NEW | Original query is ranked higher |
| REPLACE | The original query is discarded and the generated |
| | query remains. |

A category grouping rule may be of the form “QUERYPATTERN→category1, category2, . . . , categoryN (SHOW digit_literal)?” To illustrate the semantics of such a rule, consider the grouping rule [d=PERSON]→category 1, category 2, COMPANY NAME_category 3 SHOW 1. The rule states that for any query that contains the mention of a person name, all the search results that belong to the category “category 1” must be grouped together (similarly for the categories “category 2” and “category N”) and only one result is shown for results from that category.

Category grouping rules are typically used to ensure that users see a diverse set of search results as opposed to seeing entire pages of results dominated by results from a particular web collection, site, or host. Note that grouping rules have no impact on the overall ordering/ranking. In other words, the positions of the grouped results are simply the positions of the top-ranked results from those corresponding categories in the raw ungrouped search result.

Category ranking rules are an extension to grouping rules that have the additional effect of influencing ranking. A category ranking rule “QUERYPATTERN→category1, category2, . . . , categoryN”, states that for any search query that matches the pattern on the left, not only are the pages in the specified categories grouped together, but they are pulled up to the head of the ranked result list.

In particular, the grouped result for category1 must become the top most result followed by the corresponding result for category2, et cetera, followed eventually by the normal results in their original order. For example, the same rule described above, [d=PERSON]→category 1, category 2, COMPANY NAME_category 3, when specified as a ranking rule, will have the effect of forcing a “category 1” category result to the top of the list, followed by category 2, et cetera.

Similarly, the ranking rule “[d=COMPANY NAME_INTERNAL_SOFTWARE]→category 1, category 2, category 3, category 4, category 5” states that when a query contains the name of any software that is used internally within COMPANY NAME, results from “category 1” should be grouped and pulled right on top, followed in order by “category 2”, “category 3”, et cetera. Note that if multiple grouping rules come into play for a given query (that is, the query patterns in multiple rules match that query), the groupings specified by all of those rules are performed. However, when multiple ranking rules come into play for the same query, the rules are applied one after another, in the order in which they are listed in the rule file. Thus, unlike grouping rules, the order in which category ranking rules are listed in the rule file is important, at least in one example embodiment. Note also that for grouping rules, the order of the category labels on the right hand side is not significant and is merely syntactic for multiple independent rules, one per category. On the other hand, the order of category labels is significant for ranking rules as it dictates the ordering of the grouped search results. To instruct the engine to always group/rank certain categories, a rule can be used such as “ANY→category1, category2, . . . , categoryN (SHOW digit_literal)”.

A third and powerful form of runtime rules are the rewrite rules. In contrast with the previous two rule types, rewrite rules provide the administrator with the ability to alter, augment, or even replace the actual search query received from the user.

With reference to FIG. 2, rewrite rules affect the query generation phase (phase 1) of the runtime engine, whereas category rules primarily affect the result aggregation phase (phases 2-3). Plain rules are used for a variety of UI related configuration tasks. A generic rewrite rule is of the form

QUERYPATTERN → REWRITE_TYPE REWRITE_PATTERN
(LIMIT digit_literal)? (APPLY_TO_ALL)?

As before, the left hand side of the rule is a query pattern. Given a parsed query that matches this query pattern, the rewrite rule generates another parsed query as output. The REWRITE_PATTERN specifies how the output query is to be produced by starting with a copy of the input query and deleting, modifying, or adding new terms. REWRITE_TYPE is an optional modifier that controls how the generated parsed query should be treated relative to the input query with regard to ranking (partial ordering). LIMIT digit_literal is an optional modifier that controls how many results should be returned for results obtained by queries that are generated by the rewrite pattern. Table 2 shows four example values of the REWRITE_TYPE modifier.

Use of the modifier OR indicates that the generated parsed query is to be treated identical to the incoming parsed query from the viewpoint of ranking, that is, the effective query issued against the search indexes is an “OR” of the incoming parsed query and the generated parsed query. The modifier NEW_OVER_ORIG states that the output query is strictly better than the input query; as a result, all of the results produced from the generated query are to be ranked higher than those produced by the input query. The ORIG_OVER_NEW modifier reverses this ordering; all results produced by the generated query are ranked lower than the results produced by the input query. Finally, REPLACE states that the input query is to be discarded and only the output query survives after the application of the rewrite rule.

For example, consider the rewrite rule:

[r=teas|tea]→OR expense reimbursement

The query pattern on the left matches queries such as teas, filing teas, wwer USA, and Canada to (where “tea(s)” is shorthand for “travel and expense”. For each such query, an embodiment replaces the tokens that match the query pattern on the left with the tokens specified by the replacement pattern. Thus, the effect of applying this rewrite rule for each of these input queries is as shown below:

teas - - - expense reimbursement

filing teas - - - filing expense reimbursement

Canada tea - - - Canada expense reimbursement

Since the rewrite type modifier is OR, the generated and input queries are treated identical with respect to ranking In other words, if the input query was “Canada tea”, the effective query issued against the search indexes would be “Canada tea” OR “Canada expense reimbursement”. In this example, the effect of applying the rewrite rule is synonym expansion, where the synonym “expense reimbursement” has been used in place of “tea(s)”, et cetera. However, as described herein, rewrite rules enable significantly more powerful transformations than applying synonyms.

For example, consider the rewrite rule

EQUALS cs Australia→NEW_OVER_ORIG cs Australia all topics library.

This rule exploits the search administrator's domain knowledge that the CS website for COMPANY NAME Australia maintains an index page of all CS topics titled “all topics library”. Given an input query “cs Australia”, this rewrite rule will result in the execution of two queries: “cs Australia all topics library” and “cs Australia”. Furthermore, the results from the first query will be ordered above those of the second. This ensures that the index page shows up as the topmost search result.

The same idea can be generalized to apply to all countries. Now, the left hand side can be easily changed to EQUALS cs [d=COUNTRY]. This will ensure that the rule applies whenever the query consists of exactly the word “cs” followed by the name of a country. On the right hand side, the ability to carry forward the parsed token corresponding to the matched country name is needed. The syntax used for this construct is shown below:

EQUALS cs [d=COUNTRY]→NEW_OVER_ORIG cs [!0] all topics library

The parsed tokens in “[ ]” on the left hand side are numbered sequentially starting with 0 and can be referenced on the right hand side with the special syntax [!n] where n is the position of the token on the left hand side. In this case, “!0” is the token corresponding to the country name. Sample applications of this rewrite rule are given below:

cs Indonesia - - - cs Indonesia all topics library

cs India - - - cs India all topics library

For simplicity, multiple rewrite rules of the same query pattern but different rule patterns can be expressed in a simple rule and separated from each other by “|”. For instance the following two rewrite rules:

[r=teas|tea]→OR expense reimbursement

[r=teas|tea]→ORIG_OVER_NEW reimbursement

can be expressed as a single rewrite rule:

[r=teas|tea]→(OR expense reimbursement)|
(ORIG_OVER_NEW reimbursement)

Interaction between different rule types is provided such that different rules may interact with other rules of the same or different types. Herein are provided some examples of possible interactions.

Interactions between rewrite rules and other runtime rules. All plain and category rules are matched against the original input queries and not against additional queries generated by rewrite rules. This decision may be made to allow rule writers to think about each type of rule in isolation without having to worry deeply about complex rule interactions. The exceptions to this may be REPLACE rules. Unlike other types of rewrite rules that generate additional parsed queries but keep the original query untouched, REPLACE rules substitute the input query with the generated query. Thus, all subsequent actions including the application of plain and category rules is now based on the query generated by the REPLACE rule.

Interactions between rewrite rules. Amongst rewrite rules themselves, REPLACE rules are applied first, ahead of NEW_OVER_ORIG, ORIG_OVER_NEW, and OR. Starting with the input query, the search runtime scans the REPLACE rules in the order in which they occur in the rule file. When a rule applies, the input query is replaced by the generated query. Thereafter, this generated query is treated as the current query and an embodiment continues the scan of the rule file, starting with the rule following the one that was applied. This process may repeat until all REPLACE rules are exhausted.

For example, given the sequence of rewrite rules:

global delivery→REPLACE global delivery framework

global delivery framework→REPLACE gsdf category:COMPANY NAME_global_services an input query [global] [delivery] [procedures] will get replaced by [gsdf] [procedures] [category:COMPANY NAME_global_services] once all REPLACE rules have been applied.

Except for REPLACE rules, all other rewrite rules may apply independently without interactions with each other, except when they are explicitly marked as APPLY_TO_ALL. When a rewrite rule is marked as APPLY_TO_ALL, then the rule is not only applied to the original query but also all the queries generated so far by rules of the same type. If multiple NEW_OVER_ORIG rules apply, then all the corresponding queries are generated, executed, and their combined results are ranked higher than the results of the original query. The results of multiple such generated queries are then combined based on the internal ranking algorithm of the search engine to obtain search results.

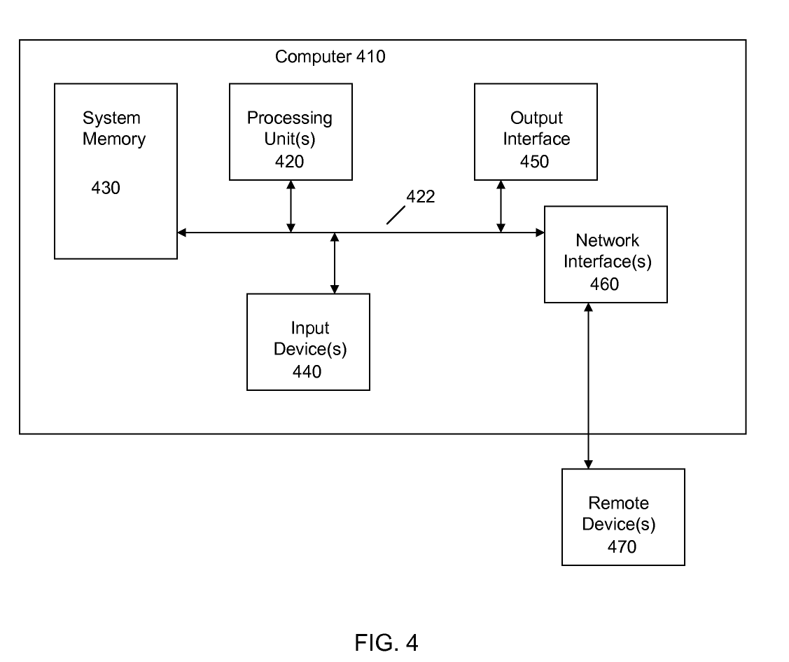

Accordingly, an embodiment provides for facilitating improved keyword searching of enterprise datasets using domain knowledge. Referring to FIG. 4, it will be readily understood that embodiments may be implemented using any of a wide variety of devices or combinations of devices. An example device that may be used in implementing embodiments includes a computing device in the form of a computer 410. In this regard, the computer 410 may execute program instructions configured to provide for rule-driven runtime customization of keyword search engines, and perform other functionality of the embodiments, as described herein.

Components of computer 410 may include, but are not limited to, at least one processing unit 420, a system memory 430, and a system bus 422 that couples various system components including the system memory 430 to the processing unit(s) 420. The computer 410 may include or have access to a variety of computer readable media. The system memory 430 may include computer readable storage media in the form of volatile and/or nonvolatile memory such as read only memory (ROM) and/or random access memory (RAM). By way of example, and not limitation, system memory 430 may also include an operating system, application programs, other program modules, and program data.

A user can interface with (for example, enter commands and information) the computer 410 through input devices 440. A monitor or other type of device can also be connected to the system bus 422 via an interface, such as an output interface 450. In addition to a monitor, computers may also include other peripheral output devices. The computer 410 may operate in a networked or distributed environment using logical connections (network interface 460) to other remote computers or databases (remote device(s) 470). The logical connections may include a network, such local area network (LAN) or a wide area network (WAN), but may also include other networks/buses.

As will be appreciated by one skilled in the art, aspects may be embodied as a system, method or computer program product. Accordingly, aspects of the present invention may take the form of an entirely hardware embodiment, an entirely software embodiment (including firmware, resident software, micro-code, et cetera) or an embodiment combining software and hardware aspects that may all generally be referred to herein as a “circuit,” “module” or “system.” Furthermore, aspects of the present invention may take the form of a computer program product embodied in at least one computer readable medium(s) having computer readable program code embodied therewith.

Any combination of at least one computer readable medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible or non-signal medium that can contain or store a program for use by or in connection with an instruction execution system, apparatus, or device.

Program code embodied on a computer readable medium may be transmitted using any appropriate medium, including but not limited to wireless, wireline, optical fiber cable, RF, et cetera, or any suitable combination of the foregoing.

Computer program code for carrying out operations for embodiments may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments are described with reference to figures. It will be understood that portions of the figures can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Although illustrated example embodiments have been described herein with reference to the accompanying drawings, it is to be understood that embodiments are not limited to those precise example embodiments, and that various other changes and modifications may be affected therein by one skilled in the art without departing from the scope or spirit of the disclosure.

1-9. (canceled)

10. A computer program product for rule-driven customization of keyword searches, comprising:
a computer readable storage medium having computer readable program code embodied therewith, the computer readable program code comprising:
computer readable program code configured to receive an input keyword query;
computer readable program code configured to determine from the input keyword query and a dataset to be queried at least one rule selected from the group consisting of: a re-write rule; a category ranking rule, and a category grouping rule; and
computer readable program code configured to apply the at least one rule to generate search results based on domain knowledge of the dataset.

11. The computer program product of claim 10, wherein said at least one re-write rule is applied to said input keyword query responsive to said input keyword query matching a query rewrite pattern.

12. The computer program product of claim 11, wherein said at least one re-write rule specifies how said input keyword query is to be modified.

13. The computer program product of claim 12, wherein the input keyword query is modified by at least one of: changing at least one keyword of said input keyword query, adding at least one keyword to said input keyword query, and deleting at least one keyword from said input keyword query.

14. The computer program product of claim 10, further comprising computer readable program code configured to partially order a plurality of queries produced in response to applying said at least one re-write rule.

15. The computer program product of claim 10, wherein the category grouping rule is applied responsive to a query matching a pattern of the category grouping rule.

16. The computer program product of claim 15, wherein said category grouping rule groups in output of said search results a plurality of search results matching a category associated with said category grouping rule.

17. The computer program product of claim 10, wherein said category ranking rule ranks to a higher ranking in output of said search results a search result matching a category associated with said category ranking rule.

18. The computer program product of claim 17, wherein said category ranking rule ranks results obtained using said input keyword query higher than results obtained using an additional query generated using said re-write rule.

19. A system for rule-driven customization of keyword searches, comprising:
at least one processor; and
a memory device operatively connected to the at least one processor;
wherein, responsive to execution of program instructions accessible to the at least one processor, the at least one processor is configured to:
receive an input keyword query;
determine from the input keyword query and a dataset to be queried at least one rule selected from the group consisting of: a re-write rule; a category ranking rule, and a category grouping rule; and
apply the at least one rule to generate search results based on domain knowledge of the dataset.

20. The system of claim 19, wherein:
said re-write rule is applied to said input keyword query responsive to said input keyword query matching a query rewrite pattern; and
said re-write rule specifies how said input keyword query is to be modified.
